(19) United States
(12) Patent Application Publication
(10) Pub. No.: US 2013/0308841 A1
(43) Pub. Date: Nov. 21, 2013

(54) METHOD AND APPARATUS FOR IMAGE PROCESSING

(71) Applicant: Samsung Electronics Co., Ltd., Suwon-si (KR)

(72) Inventors: Jin-woo YIM, Seongnam-si (KR); Jong-geun PARK, Seoul (KR); Jae-chool LEE, Suwon-si (KR); Hae-kyung JUNG, Seoul (KR)

(73) Assignee: SAMSUNG ELECTRONICS CO., LTD., Suwon-si (KR)

(21) Appl. No.: 13/896,992

(22) Filed: May 17, 2013

(30) Foreign Application Priority Data
May 17, 2012 (KR) 10-2012-0052596

(51) Int. Cl. G06T 5/00

(52) U.S. Cl. CPC G06T 5/002
USPC 382/128

(57) ABSTRACT

An image processing method and apparatus includes receiving a transmission image as an input image, obtaining a threshold which is applied to noise removal, based on at least one image information from among information related to a pixel intensity of the input image and an edge map, and removes noise in the input image by using the threshold.

### CROSS-REFERENCE TO RELATED PATENT APPLICATION

This application claims the benefit of Korean Patent Application No. 10-2012-0052596, filed on May 17, 2012, in the Korean Intellectual Property Office, the disclosure of which is incorporated herein by reference, in its entirety.

### BACKGROUND

1. Field

One or more exemplary embodiments of the present disclosure relate to an image processing method and apparatus. More particularly, exemplary embodiments relate to a method of receiving an object transmission photographing image (hereinafter referred to as a transmission image) such as a radiographic transmission image, and removing noise included in the image and an apparatus for performing the same.

2. Description of the Related Art

Representative types of medical images for medical inspections may include x-ray images and computer tomography (CT) images.

X-ray images and CT images are transmission images obtained by photographing an internal structure of an object in which photons are irradiated to the object to be photographed. Specifically, the X-ray images and the CT images are obtained by exposing the object to X-ray radiation.

Since the X-ray radiation is harmful to human health, there is a growing tendency toward reducing the X-ray radiation dosage used for an X-ray photographing apparatus. However, a reduction in X-ray radiation dosage may result in an increase in noise in the X-ray image. Accordingly, various methods for improving image quality are being developed in order to reduce the noise in the image. For example, when X-ray radiation dosage is reduced in X-ray photographing, the Poisson noise may increase in the X-ray image. Therefore, it is necessary to develop a method of improving image quality or processing of a signal, in order to remove the Poisson noise while using a reduced X-ray dosage.

Therefore, it is necessary to provide a method and apparatus for processing a transmission image so as to reduce generated noise from the transmission image.

### SUMMARY

One or more aspects of the exemplary embodiments provide an image processing method and an apparatus for irradiating a radioactive substance to an object and for reducing noise included in a photographed input image.

According to an aspect of the exemplary embodiments, there is provided an image processing method including: receiving as an input image an object transmission photographed image; obtaining a threshold which is applied to remove noise, based on at least one from among information relating to a pixel intensity of the input image, and an edge map; and removing the noise from the input image by using the threshold.

The information relating the pixel intensity may include information related to a variance of the pixel intensity in a predetermined pixel which is included in the input image.

The obtaining of the threshold may include increasing the threshold in proportion to a variance, based on the information relating to the variance of the pixel intensity.

The obtaining of the threshold may include reducing the threshold, which is applied to remove the noise in an edge area which is included in the input image, based on the edge map.

The information relating to pixel intensity may include information related to the pixel intensity of the predetermined pixel included in the input image and the variance of pixel intensity.

The image processing method may further include dividing a range of pixel intensity into N segments, and obtaining information related to the pixel intensity, which respectively corresponds to the divided range of the pixel intensity, and a variance of the pixel intensity.

The obtaining of the threshold may include obtaining the threshold for each segment of the pixel intensity.

The image processing method may further include implementing a multi-scale transform of the input image, and obtaining information related to the variance of the pixel intensity, respectively for 0th through nth scaled images which are scaled down into 0th through Nth scales.

The obtaining of the threshold may include selecting one image that ensures a linearity between the pixel intensity and the variance, from among the 0th through nth scaled images, and obtaining the threshold, based on information related to the pixel intensity in the selected image.

The removing of the noise may include, in response to the pixel intensity of the predetermined pixel, in the selected image, being equal to or less than the threshold, removing the noise by using the threshold.

The removing of the noise may further include removing the noise by non-linear filtering at least one image other than the selected image from among the 0th through nth scaled images.

According to an aspect of an exemplary embodiment, there is provided an image processing apparatus including an image receiver configured to receive an object transmission photographed image as an input image, and an image processor configured to obtain a threshold which is applied to remove noise, based on at least one information from among information related to a pixel intensity of the input image and an edge map, and removing noise from the input image by using the threshold.

An aspect of an exemplary embodiment may provide an image processing apparatus for removing noise from an image, the image processing apparatus including: an image receiver configured to receive a transmission image as an input image; and an image processor configured to obtain a threshold which is applied to remove noise, based on at least one image information from among information related to a pixel intensity of the input image and an edge map, and removing noise in the input image by using the threshold, wherein the image processor reduces the threshold, which is applied to noise removal in an edge area of the input image, based on the edge map, and an edge enhancer configured to adjust the pixel intensity at the edge in the input image.

The image processor may include an information obtainer configured to divide a range of the pixel intensity into N segments, and obtaining information related to the pixel intensity, where the information obtains the threshold for each segment of the pixel intensity.

An aspect of an exemplary embodiment may include a scaler configured to implement a multi-scale transform of the input image.

An information obtainer may be configured to obtain information related the variance of the pixel intensity, respectively for 0th through nth scaled images which are scaled down on 0th through nth scales by implementing a multi-scale transform.

### BRIEF DESCRIPTION OF THE DRAWINGS

The above and other features and advantages will become more apparent by describing in detail exemplary embodiments with reference to the attached drawings in which:

FIG. 1 is a block diagram which illustrates an image processing apparatus according to an exemplary embodiment;

FIGS. 2A and 2B are graphs showing a threshold obtained by the image processing apparatus of FIG. 1;

FIG. 3 is a detailed block diagram which illustrates the image processor of FIG. 1;

FIG. 4 is a flowchart view which illustrates an image processing method according to an exemplary embodiment;

FIG. 5 is a block diagram which illustrates an image processing apparatus according to another exemplary embodiment;

FIG. 6 shows images which illustrate an operation of the scaler of FIG. 5;

FIGS. 7A through 7C are graphs showing an operation of the information obtainer of FIG. 5; and

FIG. 8 is a flowchart which illustrates an image processing method according to another exemplary embodiment.

### DETAILED DESCRIPTION OF THE EXEMPLARY EMBODIMENTS

Hereinafter, a method and apparatus for processing according to one or more exemplary embodiments, will be fully described with reference to the attached drawings.

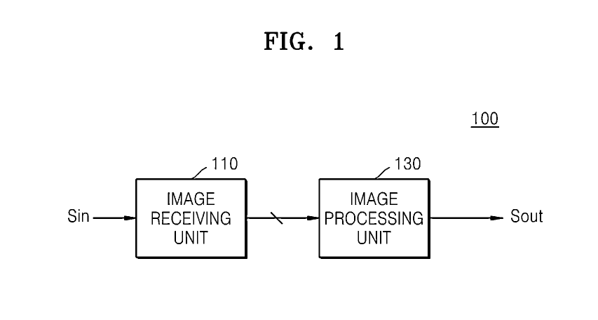

FIG. 1 is a block diagram which illustrates an image processing apparatus according to an exemplary embodiment.

Referring to FIG. 1, the image processing apparatus 100, according to an exemplary embodiment, includes an image receiver 110 and an image processor 130. Specifically, the image processing apparatus 100 is an apparatus configured to receive a transmission image and perform image processing, such as removal of noise. The transmission image is an image obtained by photographing an internal structure of an object irridated with predetermined photons.

The image receiver 110 receives the transmission image as an input image (Sᵢₙ). The input image (Sᵢₙ) may include an X-ray image or a computer tomographic (CT) image photographed by irradiating an object with a radioactive substance. The image receiver 110 may also include an image photographer (not illustrated), thus generating an input image (Sᵢₙ). For example, in response to the image receiver 110 generating an input image (Sᵢₙ), the image receiver 110 may include an X-ray photographing device or a computed-tomography device as the image photographer (not illustrated). The input image (Sᵢₙ), received in the image receiver 110 is transmitted to the image processor 130.

The image processor 130 obtains a threshold, applied to noise removal, based on at least one image information from among information related to a pixel intensity of the input image (Sᵢₙ) and information related to an edge included in the input image (Sᵢₙ). Then, the image processor 130 removes noise included in the input image (Sᵢₙ) by using the obtained threshold. The pixel intensity of the input image (Sᵢₙ) is a value which corresponds to a value of pixels included in the input image (Sᵢₙ). The pixel intensity may be expressed as a gray level data value or as a brightness value of each pixel. The information related to the edge may be information for determining an edge map of an image or a boundary in the image.

Specifically, the information related to the pixel intensity may include information related to a variance of the pixel intensity in a predetermined pixel included in the input image (Sᵢₙ).

Additionally, the information related to the pixel intensity may be obtained for each pixel intensity from among the pixels included in the input image (Sᵢₙ). For example, in response to the pixel intensity of the pixels included in the input image (Sᵢₙ) having an integer value ranging from 0 to 800, the information related to the pixel intensity may include variance information related to 800 pixel intensities which respectively correspond to the pixel values from 0 to 800.

In response to a range of the pixel intensity of pixels included in the input image (Sᵢₙ) being divided into N segments, the information related to the pixel intensity may be respectively obtained for N segments of the divided range of the pixel intensity. For example, in response to the pixel intensity of the pixels included in the input image (Sᵢₙ) ranging from 0 to 800, and the range is divided by n=20, the range of the pixel intensity may be divided into 40 segments. In this case, the information related to the pixel intensity may include variance information related to 40 pixel intensities which respectively correspond to 40 segments. The pixel intensity which corresponds to a predetermined segment may be an average pixel intensity in the predetermined segment.

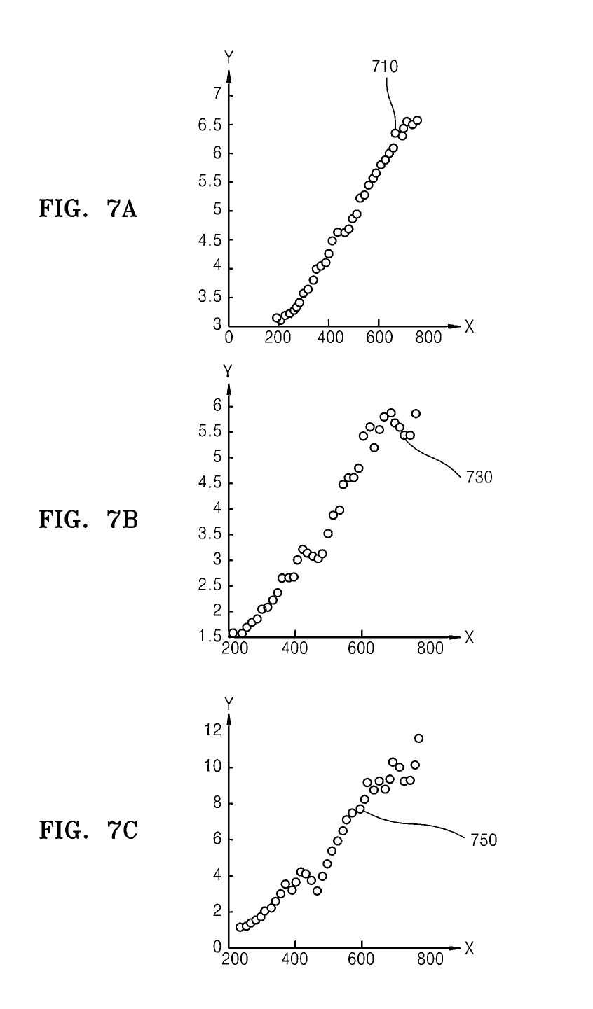

That is, the image processor 130 may divide the range of the pixel intensity into N segments, and may obtain information related to a predetermined pixel intensity, which respectively corresponds to the divided range of the pixel intensity, and a variance of the predetermined pixel intensity. The information related to the pixel intensity and a variance of the pixel intensity is described in detail by referring to FIG. 7.

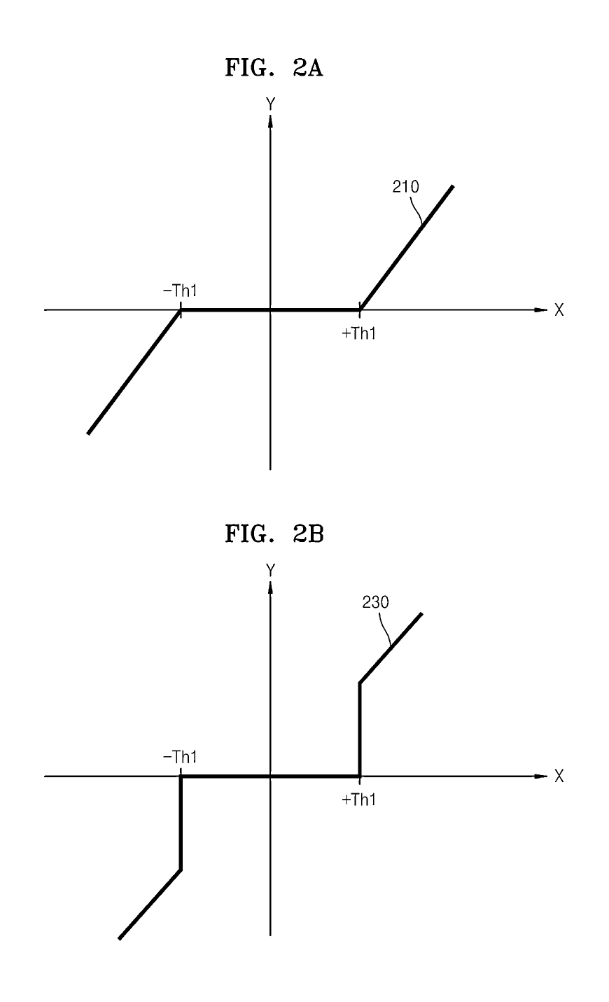

The image processor 130 may increase a threshold in proportion to a variance of the pixel intensity, based on information related to the intensity of a pixel which includes information related to a variance of the pixel intensity. The threshold is described in detail by referring to FIG. 2.

FIGS. 2A and 2B are graphs showing the threshold obtained by the image processing apparatus of FIG. 1. Referring to FIGS. 2A and 2B, an X-axis represents a threshold applied to a predetermined pixel in an input image (Sᵢₙ), and a Y-axis represents a pixel value in an input image in which noise is removed by applying the threshold to the pixels. A graph 210 in FIG. 2A shows a soft threshold, and a graph 230 in FIG. 2B shows a hard threshold.

The threshold is not a video signal, but rather is a reference value for determining a pixel as noise when the intensity of the pixel is equal to or less than a predetermined value. In response to the pixel intensity of the predetermined pixel being equal to or less than the threshold, a value of the predetermined pixel may be changed to 0 or a predetermined offset value, so that noise included in the predetermined pixel may be removed. That is, in response to the intensity of the predetermined pixel being equal to or less than the threshold, a determination is made that the value of the predetermined pixel is due to noise, and is not due to a video signal.

The soft threshold and the hard threshold are the same from a point of view that the pixel intensity that is equal to or less than the threshold, is changed to 0 or to a predetermined offset value. However, in response to the pixel intensity being equal to or greater than the threshold, noise is removed and thus the output pixel intensities differ from each other. Hereinafter, a pixel intensity of video data, before processing noise removal by applying a threshold, is referred to as an “original pixel intensity”. A pixel intensity of video data, after processing noise removal by applying a threshold, is referred to as a “changed pixel intensity”. Accordingly, in FIGS. 2A and 2B, the X-axis represents the original pixel intensity, and the Y-axis represents the changed pixel intensity.

Referring to FIG. 2A, when a threshold is set to Th1 which is a soft threshold, in response to the original intensity of a predetermined pixel, included in the input image (Sᵢₙ), is equal to or less than Th1, the original pixel intensity may be changed to 0. On the contrary, in response to the original pixel intensity being equal to or greater than Th1, the changed pixel intensity may be changed and output as a value which is proportional to the original pixel intensity. In case of removing noise by using the soft threshold, as illustrated in FIG. 2A, the changed pixel intensity, at a point in which the original pixel intensity is Th1, may be set to 0.

Referring to FIG. 2B, when a threshold is set to Th1 which is a hard threshold, if the original intensity of a predetermined pixel, included in the input image (Sᵢₙ), is equal to or less than Th1, the original pixel intensity may be changed to 0. On the contrary, if the original pixel intensity is equal to or greater than Th1, the changed pixel intensity may be output as the same value as the original pixel intensity.

Furthermore, the image processor 130 may reduce a threshold, which is applied to remove noise, in an edge area included in an input image (Sᵢₙ), based on an edge map. With regard to the input image (Sᵢₙ), the edge needs to be enhanced for improvement of image quality. That is, it is necessary to obtain a clear edge to clearly identify a photographed object in an image. Accordingly, by reducing the threshold which is applied to an edge area, it is possible to thoroughly perform noise removal in the edge area, or not to perform the noise removal.

The image processor 130 may generate an output image (Sₒᵤₜ) by removing noise included in the input image (Sᵢₙ), as stated above.

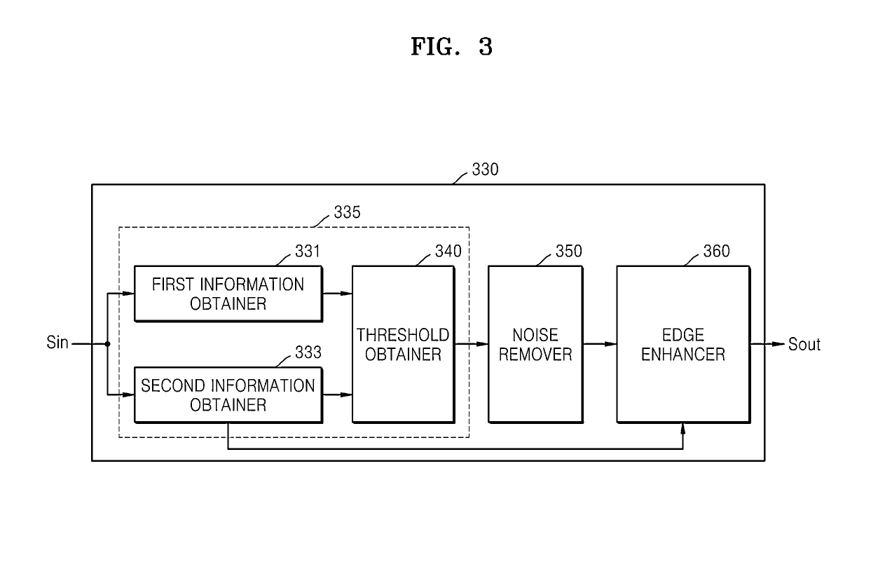

FIG. 3 is a detailed block diagram illustrating the image processor 130 of FIG. 1. Referring to FIG. 3, an image processing unit 330 corresponds to the image processing unit 130 of FIG. 1, and thus, the description of the corresponding elements will not be described again here.

Referring to FIG. 3, the image processor 330 may include an information obtaining unit 335 and a noise remover 350. Additionally, the image processor 330 may further include an edge enhancer 360.

The information obtainer 335 creates or receives at least one from among information about pixel intensity of an input image (Sᵢₙ), and an edge map of the input image (Sᵢₙ), which are information to be referred to in order to calculate a threshold. Then, the information obtainer 335 obtains a threshold applied to removal of noise in the input image (Sᵢₙ), based on at least one image information from among the information related to the pixel intensity of the input image (Sᵢₙ), and the edge map of the input image (Sᵢₙ).

Specifically, the information obtainer 335 may include a first information obtainer 331, a second information obtainer 333, and a threshold obtainer 340.

The first information obtainer 331 obtains information relating to the pixel intensity. The information related to the pixel intensity may be externally received. Additionally, the first information obtainer 331 receives an input image (Sᵢₙ) and creates information related to the pixel intensity from the received input image (Sᵢₙ).

The second information obtainer 333 obtains information related to an edge map of the input image (Sᵢₙ) or an edge included in the input image (Sᵢₙ). The information about the edge map or the edge may be externally received. Additionally, the first information obtainer unit 331 receives the input image (Sᵢₙ) and generates information related to the edge map or the edge from the received input image (Sᵢₙ).

The threshold obtainer 340 obtains a threshold, based on at least one image information from among the information related to the pixel intensity and the edge map which are obtained from at least one of the first information obtainer 331 and the second information obtainer 333. Specifically, the threshold obtainer 340 may obtain a threshold by considering both the information related to the pixel intensity and the edge map which are obtained from the first information obtainer 331 and the second information obtainer 333. In this case, a more optimized threshold may be obtained.

The noise remover 350 is configured to remove noise included in the input image (Sᵢₙ) by applying the threshold obtained at the threshold obtainer 340.

Additionally, the edge enhancer 360 executes an edge enhancement, in order to obtain a clear edge included in the input image (Sᵢₙ) in which noise is removed. Specifically, the edge enhancer 360 may adjust the pixel intensity at the edge in the input image (Sᵢₙ), based on the information related to the edge map or the edge, which are obtained from the second information obtainer 333, so as to obtain clear boundaries included in the input image (Sᵢₙ).

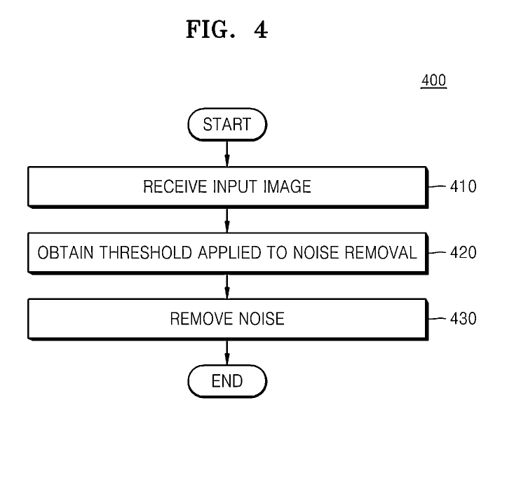

FIG. 4 is a flowchart which illustrates an image processing method 400 according to an exemplary embodiment. The image processing method, illustrated in FIG. 4, may be performed by using the image processing apparatus 100 according to an exemplary embodiment, by referring to FIGS. 1 through 3. Therefore, the image processing apparatus 100 and the image processor 330 are described above by referring to FIGS. 1 through 3, and thus, will not be described again, herein.

Referring to FIG. 4, in operation 410 of the image processing method 400, according to an exemplary embodiment, a transmission image is received as an input image (Sᵢₙ). The operation 410 may be executed at the image receiver 110.

In operation 420, a threshold which is applied to noise removal is obtained, based on at least image information one from among information related to pixel intensity and an edge map of the input image (Sᵢₙ) received in the operation 410. The operation 420 may be executed at the imaging processors 130 or 330. Specifically, the operation 420 may be executed at the information obtainer 335 included in the image processor 330.

In operation 430, noise in the input image (Sᵢₙ) is removed by using the threshold obtained in the operation 420. The operation 430 may be executed at the imaging processors 130 or 330. Specifically, the operation 430 may be executed at the noise remover 350 which is configured to be included in the image processor 330.

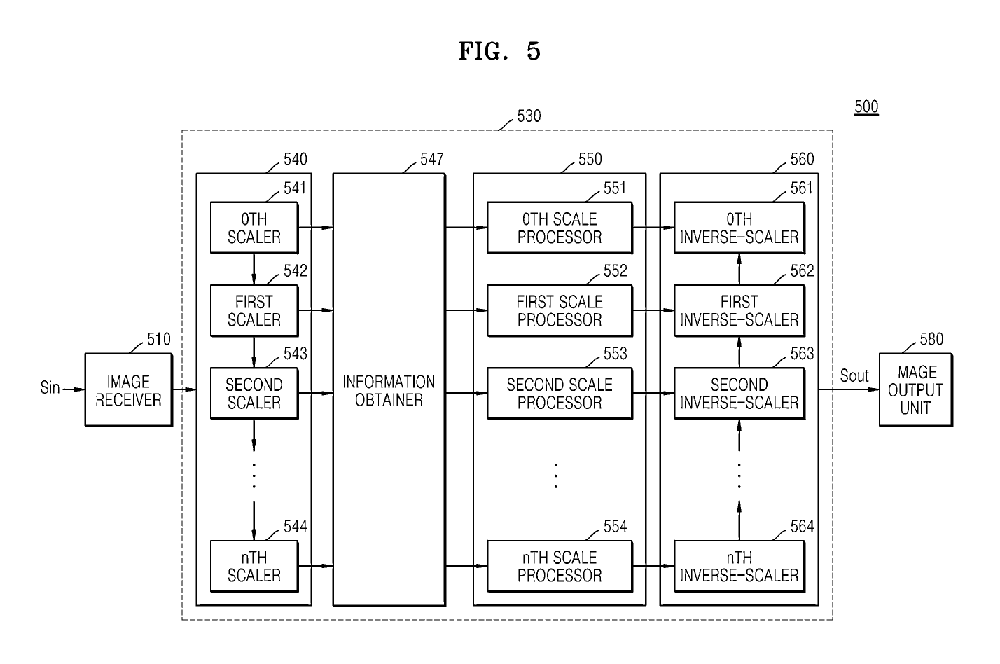

FIG. 5 is a block diagram which illustrates an image processing apparatus according to another exemplary embodiment. The image processing apparatus 500 illustrated in FIG. 5 corresponds to the image processing apparatus of FIG. 1. Additionally, an image receiver 510 included in the image processing apparatus 500 corresponds to the image receiver 110 included in the image processing apparatus 100 of FIG. 1. An image processor 530, an information obtainer 547 and a noise remover 550 included in the image processor 530 correspond to the image processor 330, the information obtainer 335 and the noise remover 350 included in the image processor 330 of FIG. 3. Therefore, the detailed description of the same elements as those of FIGS. 1 to 3 will not be described again herein.

Additionally, the image processing apparatus 500 may further include an image processor 580, compared to the image processing apparatus 100 of FIG. 1.

Referring to FIG. 5, the image receiver 510 receives an input image (Sin) and transmits the input image to the image processor 530.

The image processor 530 includes a scaler 540, an information obtainer 547, a noise remover 550, and an inverse-scaler 560. Additionally, the image processor 530 may further include the edge enhancer 360 illustrated in FIG. 3, though not illustrated in FIG. 5. In response to the image processor 530 further including the edge enhancer 360, the edge enhancer 360 may be disposed at the rear end of the inverse-scaler 560.

The scaler 540 is configured to implement a multi-scale transform of an input image (Sᵢₙ). The multi-scale transform is an image processing technology for adjusting a size and resolution of the input image (Sᵢₙ). A wavelet transform may also be used as the multi-scale transform.

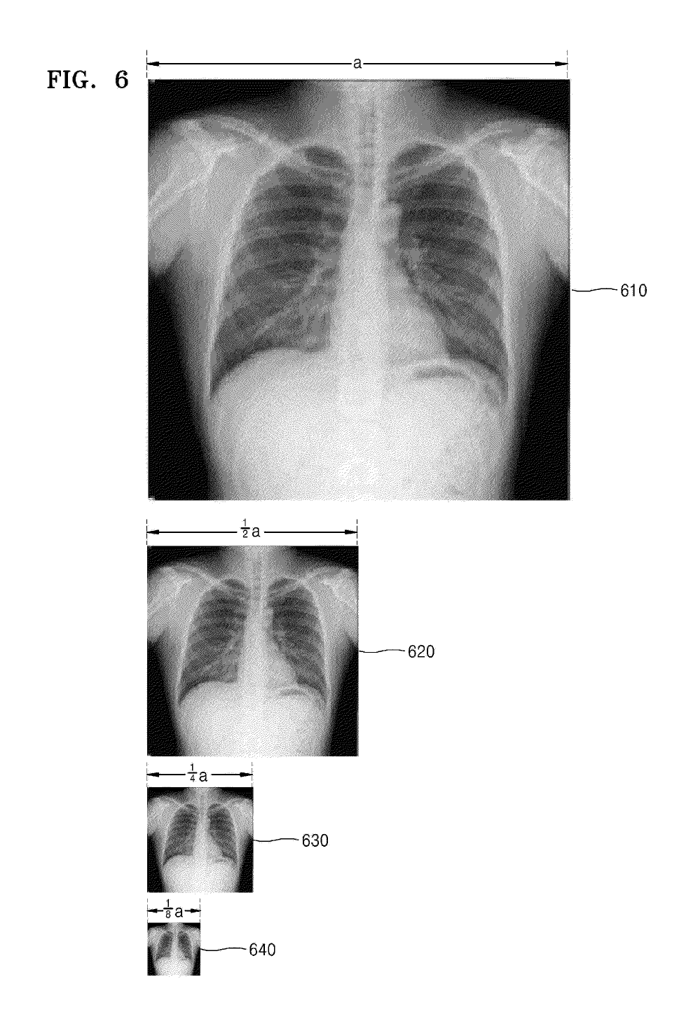

The scaler 540 may include a plurality of 0th to nth scalers 541 through 544, for scaling down the input image (Sᵢₙ) in multiple stages. Hereinafter, an image output from the scaler 540 is described in detail, by referring to FIG. 6.

FIG. 6 is a diagram describing an operation of the scaler of FIG. 5.

Referring to FIGS. 5 and 6, the 0th scaler 541 outputs an image without changing a size of the input image (Sᵢₙ). Hereinafter, an image, with the same size as the input image (Sᵢₙ), is referred to as a scale-0, and an image, output from the 0th scaler 541, is referred to as a 0th scaled image. An image 610 illustrated in FIG. 6 is the input image (Sᵢₙ), and has a width of “a.”

The first scaler 542 outputs an image obtained by reducing a size of the input image (Sᵢₙ) to ¼. Hereinafter, an image, obtained by compressing the input image (Sᵢₙ) by one stage to reduce a width and a length to ½, is referred to as a scale-1. An image, output from the first scaler 542, is referred to as a first scaled image. An image 620, illustrated in FIG. 6, is an image which is output from the first scaler 542. The image 620 has a width of ½ a.

The second scaler 543 outputs an image obtained by reducing a size of the input image (Sᵢₙ) to 1/16. Hereinafter, an image, obtained by compressing the input image (Sᵢₙ) by two stages to reduce a width and a length to ¼, is referred to as a scale-2. An image, output from the second scaler 542, is referred to as a second scaled image. An image 630, illustrated in FIG. 6, is an image which is output from the second scaler 543. The image 630 has a width of ¼ a.

Additionally, in response to the scaler 540 dividing the input image (Sᵢₙ) by three stages, the nth scaler 544 may be the third scaler 544, and the third scaler 544 outputs an image by reducing the input image (Sᵢₙ) to 1/64. Hereinafter, as an example, the nth scaler 544 is assumed as the third scaler 544. An image, obtained by compressing the input image (Sᵢₙ) by three stages to reduce a width and a length to ⅛, may be referred to as a scale-3. An image 640, illustrated in FIG. 6, is an image which is output from the third scaler 544. The image 640 has a width of ⅛ a.

A multi-resolution transform is commonly understood by one of ordinary skill in the art to which exemplary embodiments belong, and thus, will not be described in detail herein.

The information obtainer 547 obtains information relating to a variance of the pixel intensity, which is the information related to the pixel intensity, respectively for 0th through nth scaled images divided on 0th through nth scales by using multi-scale transforms. That is, the information obtainer 547 obtains the information related to the variance of the pixel intensity respectively from the 0th scaled image, from the first scaled image, from the second scaled image, and from the third scaled image.

Additionally, the information obtainer 547 may obtain only information related to an edge map or an edge in an input image (Sᵢₙ) with a 0th scale.

The information obtainer 547 may select one image from information among the 0th through nth scaled images that ensure linearity between the pixel intensity and the variance, and may obtain a threshold, based on information related to the pixel intensity in the selected input image (Sᵢₙ). The selection, by the information obtainer 547, of the input image (Sᵢₙ) is described in detail, by referring to FIGS. 7A through 7C.

FIGS. 7A through 7C are graphs showing an operation of the information obtainer of FIG. 5. Referring to graphs in FIGS. 7A through 7C, an X-axis represents a pixel intensity, and a Y-axis represents a variance of the pixel intensity. Specifically, the Y-axis may represent a standard variance of the pixel intensity. Additionally, in each graph illustrated in FIGS. 7A through 7C, the pixel intensity is divided into predetermined ranges, and a measured value of the standard variance, for each predetermined range, is presented as an example.

Referring to FIGS. 7A through 7C, the information obtainer 547 obtains the information related to the variance of the pixel intensity, respectively, from 0th through nth scaled images.

FIG. 7A shows a graph 710 which illustrates information related to a variance of the pixel intensity in the 0th scaled image.

FIG. 7B shows a graph 730 which illustrates information related to a variance of the pixel intensity in the 1st scaled image.

FIG. 7C shows a graph 750 which illustrates information related to a variance of the pixel intensity in the 2nd scaled image.

Specifically, the information obtainer 547 selects an image with a most excellent linearity between the pixel intensity and the variance, from among the 0th through nth scaled images. Referring to the graph 730, which corresponds to the first scaled image, the linearity is not ensured in an area where the pixel intensity ranges from 400 to 700. Additionally, referring to the graph 750, which corresponds to the second scaled image, the linearity is not ensured in an area where the pixel intensity ranges from 400 to 700.

Therefore, the information obtainer 547 may select the 0th scaled image which best ensures the linearity over all ranges of the pixel intensity, and may set a threshold based on information related to the pixel intensity which corresponds to the 0th scaled image. Specifically, when the pixel intensity increases, the information obtainer 547 may increase the threshold which is applied to noise removal in the corresponding pixel.

Additionally, as stated above, the information obtainer 547 may adjust the threshold, based on information relating to an edge map or to an edge.

Specifically, the information obtainer 547 may set the threshold, according to following Equation 1.

T(x,y)=Std(1(x,y))*Gain*(1−E(x,y)) Equation 1

where T(x,y) represents a threshold applied to a point (x,y) in an image, and |(x,y) is a pixel intensity at the point (x,y) in the image. Additionally, Std(|(x,y)) represents a standard variance of the pixel intensity at the point (x,y), and Gain represents a value applied to an original pixel intensity. E(x,y) denotes edge information according to an edge map. E(x,y) has a value close to 1 in a pixel which includes an edge, and a value close to 0 in a pixel which does not include an edge.

Accordingly, the threshold T(x,y) has a value which is proportional to a standard variance Std(|(x,y)) and a gain, and has a reduced value near a location which includes an edge. E(x,y) has a value close to 1 in a pixel which includes an edge, and a value close to 0 in a pixel which does not include an edge. Therefore, (1−E(x,y)) has a value close to 0 in a pixel which includes an edge, and a value close to 1 in a pixel which does not include an edge.

The noise remover 550 may include 0th to nth scale processors 551 through 554 which are configured to perform noise removal respectively in the 0th and first scaled images.

Specifically, with regard to an image that ensures linearity and thus, is selected at the information obtainer 547, in response to a pixel intensity of a predetermined pixel being equal to or less than the threshold, the noise remover 550 removes noise by applying a threshold to the pixel. Additionally, the noise remover 547 may remove noise by non-linear filtering at least one image, other than the selected image, from among the 0th through nth scaled images. Directional filtering or diffusion filtering may be used as the non-linear filtering. The noise remover 547 may also filter by using the threshold at least one, image other than the selected image, from among the 0th through nth scaled images.

In an example of FIGS. 7A to 7C, a 0th scaled image ensures a linearity. Therefore, a 0th scale processor 551, which removes noise from the 0th scaled image, may remove noise by applying the threshold. The first through nth scale processors 552 through 554, other than the 0th scale processor 551, may respectively remove noise by using non-linear filtering.

The inverse-scaler 560 respectively performs inverse-scaling of the 0th through nth scaled images. The inverse-scaler 560 may include a plurality of 0th to nth inverse scalers 561 through 564. Accordingly, the inverse-scaler 560 may generate an output image (Sₒᵤₜ) which has the same size or resolution as the input image (Sᵢₙ). That is, the inverse-scaler 560 is configured to perform an inverse operation of multi-resolution analysis of the scaler 540.

The image processing apparatus 500 may further include an image output 580, compared to the image processing apparatus 100 of FIG. 1.

The image output 580 may convert and output the output image (Sₒᵤₜ), which is from the image processor 530, so that a user may visually recognize and read the output image. Additionally, the image output 580 may include a display (not illustrated) which is configured to display the converted output image (Sₒᵤₜ) to the user.

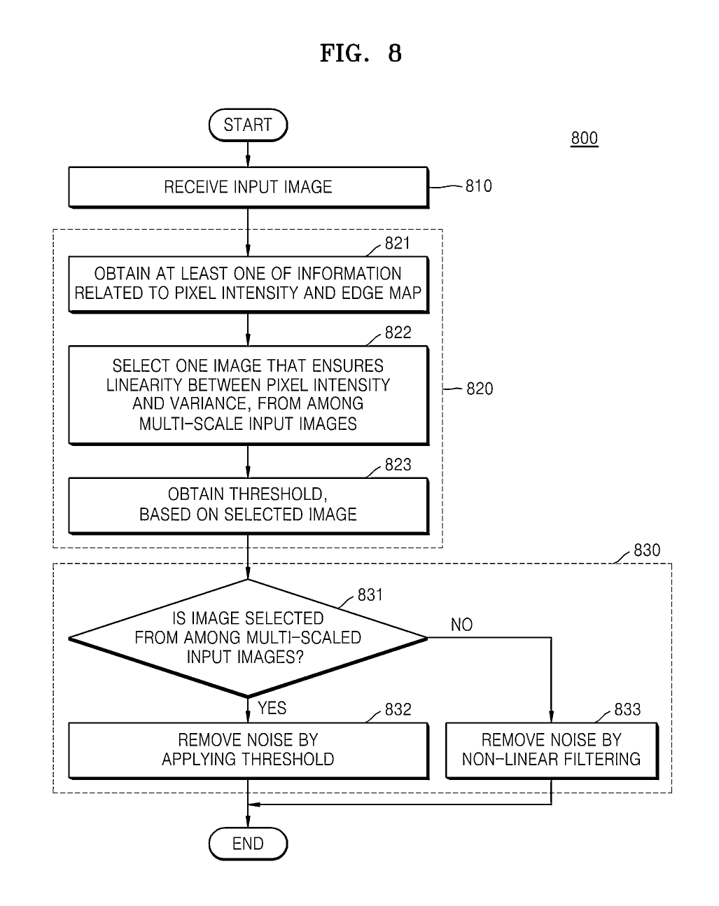

FIG. 8 is a flowchart which illustrates an image processing method according to another exemplary embodiment. The image processing method 800, illustrated in FIG. 8, may also be performed by using the image processing apparatus 500 according to another exemplary embodiment which is described by referring to FIGS. 1 through 7. Accordingly, an operation of the image processing apparatus 500 is described above by referring to FIGS. 1 through 7, and thus, the detailed description of the same elements as those of FIGS. 1 to 7 will not be described herein. Additionally, operations 810 through 830 included in the image processing method 800 correspond to the operations 410 through 430 included in the image processing method 400 of FIG. 4, and thus, will not be described again here.

Referring to FIG. 8, in operation 810, a transmission image is received as an input image (Sᵢₙ). The operation 810 may be performed at the image receiver 510.

In operation 820, a threshold to be applied for noise removal is obtained, based at least on the image information from among the information relating to pixel intensity and the edge map of the input image (Sᵢₙ) received in operation 810. The operation 820 may include operations 821 through 823.

Specifically, in operation 821, at least one image information from among the information relating to the pixel intensity and the edge map is obtained. The operation 821 may be executed at the information obtainer 547. Additionally, before the operation 821, a multi-scale transform may be implemented on the input image (Sᵢₙ), to generate a plurality of images with multiple scales (operation not illustrated). Operation for the multi-scale transform may be executed at the scaler 540.

In operation 822, one image that ensures a linearity between the pixel intensity and a variance is selected from among 0th through nth scaled images. The operation 822 may be executed at the information obtainer 547.

Then, in operation 823, a threshold is obtained, based on the information relating to the pixel intensity in the image selected in the operation 822. The operation 822 may be executed at the information obtainer 547.

In operation 831, a determination is made as to whether an image is selected from among the multi-scaled images in operation 822. Then, in response to the image being selected from the multi-scaled images in operation 822, noise removal is executed by applying a threshold in operation 832. Specifically, with regard to the selected image, in response to an intensity of a predetermined pixel being equal to or less than the threshold, noise is removed by applying the threshold.

Then, in response to a determination in operation 831 as to whether or not the image is not selected from the multi-scaled images in operation 822, non-linear filtering is executed on at least one image other than the selected image from among images among the 0th through nth scaled images in operation 833.

The operations 831 through 833 may be executed at the noise remover 550.

The method and the apparatus for image processing, according to one or more exemplary embodiments, may effectively reduce noise included in a transmission image of an object photographed by exposing the object to a radioactive substance, by variably setting the threshold, which is applied to noise removal, based on information relating to a pixel intensity of an input image.

Additionally, the threshold, which is applied to noise removal, may be variably set, based on an edge map of the input image. Thus, image quality may be improved by removing noise while preventing edge blur in the image.

While the present invention has been particularly shown and described with reference to exemplary embodiments thereof, it will be understood by those of ordinary skill in the art that various changes in form and details may be made therein without departing from the spirit and scope of the present invention as defined by the following claims.

What is claimed is:

1. A method of processing an image, the image processing method comprising:
receiving an object transmission photographed image as an input image;
obtaining a threshold which is applied to remove noise in the input image, based on at least one image information from among information related to pixel intensity of the input image and an edge map; and
removing the noise from the input image by using the threshold.

2. The method of claim 1, wherein the information relating to the pixel intensity comprises information related to a variance of the pixel intensity in a predetermined pixel which is included in the input image.

3. The method of claim 2, wherein the obtaining of the threshold comprises increasing the threshold in proportion to the variance, based on the information related to the variance of the pixel intensity.

4. The method of claim 3, wherein the obtaining of the threshold comprises reducing the threshold, which is applied to remove the noise in an edge area which is included in the input image, based on the edge map.

5. The method of claim 1, wherein the information relating to the pixel intensity comprises information related to the intensity of the predetermined pixel included in the input image and the variance of the pixel intensity.

6. The method of claim 1, further comprising dividing a range of the pixel intensity into N segments, and obtaining information related to the pixel intensity, which respectively corresponds to the divided range of the pixel intensity and a variance of the pixel intensity.

7. The method of claim 6, wherein the obtaining of the threshold comprises obtaining the threshold for each segment of the pixel intensity.

8. The method of claim 1, further comprising implementing a multi-scale transform of the input image, and obtaining information related to the variance of the pixel intensity, respectively for 0th through nth scaled images which are scaled down into 0th through nth scales.

9. The method of claim 8, wherein the obtaining of the threshold comprises:
selecting one image that ensures a linearity between the pixel intensity and the variance, from among the 0th through nth scaled images; and
obtaining the threshold, based on information related to the pixel intensity in the selected image.

10. The method of claim 9, wherein the removing of the noise comprises removing the noise by applying the threshold, in response to the intensity of the predetermined pixel, in the selected image, being equal to or less than the threshold.

11. The method of claim 10, wherein the removing of the noise further comprises removing the noise by non-linear filtering at least one image, other than the selected image, from among the 0th through nth scaled images.

12. An image processing apparatus comprising:
an image receiver configured to receive as an input image an object transmission photographed image; and
an image processor configured to obtain a threshold which is applied to remove noise, based on at least one image information from among information related to a pixel intensity of the input image and an edge map, and removing noise in the input image by using the threshold.

13. The image processing apparatus of claim 12, wherein the information related to the pixel intensity comprises information related to a variance of pixel intensity in a predetermined pixel which is included in the input image.

14. The image processing apparatus of claim 13, wherein the image processor increases the threshold in proportion to the variance.

15. The image processing apparatus of claim 14, wherein the image processor reduces the threshold, which is applied to noise removal in an edge area of the input image, based on the edge map.

16. The image processing apparatus of claim 13, wherein the image processor comprises an information obtainer configured to divide a range of the pixel intensity into N segments, and obtain information related to the pixel intensity, which respectively corresponds to the divided range of the pixel intensity, and a variance of the pixel intensity.

17. The image processing apparatus of claim 16, wherein the information obtainer obtains the threshold for each segment of the pixel intensity.

18. The image processing apparatus of claim 12, wherein the image processor comprises:
a scaler configured to implement a multi-scale transform of the input image; and
an information obtainer configured to obtain information related the variance of the pixel intensity, respectively for 0th through nth scaled images which are scaled down on 0th through nth scales by implementing the multi-scale transform.

19. The image processing apparatus of claim 18, wherein the image obtainer selects one image that ensures a linearity between the pixel intensity and the variance, from among the 0th through nth scaled images, and obtains the threshold, based on information related to the pixel intensity in the selected image.

20. The image processing apparatus of claim 19, wherein the image processor, in response to the pixel intensity of the predetermined pixel, in the selected image, being equal to or less than the threshold, removes the noise by applying the threshold, and
removes the noise by non-linear filtering at least one image, other than the selected image, from among the 0th through nth scaled images.

21. The image processing apparatus of claim 20, wherein the image processor further comprises an inverse-scaler configured to perform inverse scaling of images other than the selected images, from among the selected images and the 0th through nth scaled images, and is configured to output an output image which has the same size or resolution as the input image.

22. The image processing apparatus of claim 20, wherein the image receiver is configured to receive as the input image an X-ray image or a computed tomography (CT) image.

23. An image processing apparatus for removing noise from an image, the image processing apparatus comprising:
an image receiver configured to receive a transmission image as an input image; and
an image processor configured to obtain a threshold which is applied to remove noise, based on at least one image information from among information related to a pixel intensity of the input image and an edge map, and removing noise in the input image by using the threshold,
wherein the image processor reduces the threshold, which is applied to noise removal in an edge area of the input image, based on the edge map, and
an edge enhancer configured to adjust the pixel intensity at the edge in the input image (Sᵢₙ).

24. The image processing apparatus of claim 23, wherein the image processor comprises an information obtainer configured to divide a range of the pixel intensity into N segments, and obtain information related to the pixel intensity.

25. The image processing apparatus of claim 23, wherein the information obtainer obtains the threshold for each segment of the pixel intensity.

26. The image processing apparatus of claim 23, wherein the image processor comprises:
a scaler configured to implement a multi-scale transform of the input image.

27. The image processing apparatus of claim 23, further comprising an information obtainer configured to obtain information related the variance of the pixel intensity, respectively for 0th through nth scaled images which are scaled down on 0th through nth scales by implementing a multi-scale transform.
